(19) United States
(12) Patent Application Publication
(10) Pub. No.: US 2013/0169041 A1
(43) Pub. Date: Jul. 4, 2013

(54) WIRE HARNESS SYSTEM IN HYBRID ELECTRIC VEHICLE

(71) Applicant: Hiroki Fukaya, Yokkaichi-City (JP)

(72) Inventor: Hiroki Fukaya, Yokkaichi-City (JP)

(73) Assignee: SUMITOMO WIRING SYSTEMS, LTD., Yokkaichi-City (JP)

(21) Appl. No.: 13/821,324

(22) PCT Filed: Mar. 28, 2011
(86) PCT No.: PCT/JP2011/057601

§ 371 Date: Mar. 7, 2013

(30) Foreign Application Priority Data
Oct. 6, 2010 (JP) 2010-226944

(51) Int. Cl. B60R 16/02

(52) U.S. Cl. CPC B60R 16/0207
USPC 307/10.1

(57) ABSTRACT

A wire harness system in a hybrid electric vehicle in which HEV parts including a battery are installed in a vehicle rear part includes a floor harness that is arranged along a floor panel from a front part towards a rear part of a passenger compartment. A rear end of the floor harness is in a vicinity of a panel that separates the passenger compartment and a rear luggage compartment. A rear harness is provided separately from the floor harness and is composed of a group of electric wires for connection to vehicle rear part-installed parts that include HEV parts, including a battery, that are installed in the vehicle rear part, a rear lamp, a license-plate lamp, and the like. The floor harness, and said one floor harness and the rear harness are connected to each other when installed in the vehicle.

### BACKGROUND OF THE INVENTION

1. Field of the Invention

The present invention relates to a wire harness system in a hybrid electric vehicle (HEV), and more specifically the present invention reduces a wire harness weight increase and suppresses a wire harness size increase of a hybrid electric vehicle wire harness in which an existing wire harness that corresponds to an internal combustion engine drive system is disposed together with an additional wire harness that corresponds to a system for an HEV in which a high-energy battery and a motor for traveling are installed.

2. Description of the Related Art

Wire harnesses arranged in a conventional vehicle provided with an internal combustion engine drive system are mainly divided into five sets of large-size wire harnesses as shown in FIG. 7. These large-size wire harnesses have a total number of electric wires of about 150 or greater and a total number of connectors connected to these electric wires of about 50 or greater, and each wire harness is assembled on one wire harness workbench (i.e., a drawing board).

The five large-size wire harnesses are composed of an instrument panel harness W/H-1 arranged in the instrument panel, an engine harness W/H-2 connected to the engine, an engine room harness W/H-3 arranged in the engine room, and a right floor harness W/H-4 and a left floor harness W/H-5 arranged in the fore-aft direction along the right and left side edges of the floor. Because the number of electric wires arranged in the trunk room at the back of the vehicle is relatively small, such electric wires are incorporated in the left floor harness W/H-5.

In addition to the five large-size wire harnesses, right and left door harnesses, a roof harness, and the like are arranged in a vehicle, and the harnesses other than the large-size wire harnesses are relatively small and light-weight.

If an HEV system composed of, for example, a battery, a drive motor that is driven by the battery, and an inverter is installed in addition to a conventional internal combustion engine drive system in a hybrid electric vehicle, HEV wire harnesses are installed together with existing wire harnesses as shown in FIG. 7. Accordingly, the number of electric wires significantly increases because of the HEV wire harnesses and the number of connectors connected to electric wires significantly increases as well. Moreover, there is also an increase in the number of exterior parts such as corrugate tubes, protectors, and tapes that are applied externally to the electric wires, as well as parts such as clips to attach the electric wires to the vehicle body.

As shown in FIG. 8(A), HEV parts including the aforementioned high-energy battery B and motor (not shown) are usually installed in a concentrated manner in the luggage compartment (trunk room) at the back of the vehicle. As a result, the added HEV harness H6 is concentrated around the wire harness arranged in the trunk room.

Regarding the wire harnesses of the existing internal combustion engine drive system, because the total number of electric wires arranged in the trunk room is relatively small, the group of electric wires of the HEV harness H6 to be arranged in the trunk room are incorporated into the existing left floor harness W/H-5 as shown in FIG. 8(B).

However, in a hybrid electric vehicle, incorporation of the HEV harness H6 to be arranged in the trunk room into the left floor harness W/H-5 increases the weight of the left floor harness W/H-5 by 40 to 50% relative to the previous weight, and when specifically calculated, the left floor harness of the conventional system is about 5000 g, but about 9000 g if the HEV harness is incorporated into the left floor harness.

Accordingly, it is not possible to use a conventional workbench (i.e., a drawing board) used as a workbench to assemble the wire harness when the weight of the wire harness increases two-fold, and it is necessary to create a new large-size drawing board. Moreover, the number of wiring steps in the wire harness work performed on the drawing board increases, and handling of electric wires becomes troublesome, thus increasing work load. Moreover, there are problems in that transportation of the assembled large-size wire harnesses is troublesome and the work of arranging the wire harnesses in a vehicle is also troublesome.

Previously, the Applicant has provided in JP H6-5119A as a wire harness to be arranged in a vehicle a wire harness comprising a common circuit provided independently of the presence or absence of selectable electrical systems; and dedicated circuits one for each of the selectable electrical systems, said dedicated circuits being separated from said common circuit, wherein said common circuit and the dedicated circuits of the relating electrical systems are joined to each other via a branch connector.

Because the wire harness for the dedicated circuits connected to so-called optional electrical components and the wire harness for the fundamental common circuit that is independent of the optional electrical components are provided separately, the wire harness of JP H6-5119A cannot cope with the sudden addition of the HEV harness that is always provided in a hybrid electric vehicle.

The present invention has been conceived in view of the foregoing problems, and an object of the present invention is to provide a hybrid electric vehicle wire harness system that yields good wire harness assembly workability and good wire harness arrangement workability for wire harness arrangement in a vehicle even when the HEV harness is suddenly added.

### SUMMARY OF THE INVENTION

In order to solve the foregoing problems, the present invention provides a wire harness system in a hybrid electric vehicle in which HEV parts including a battery are installed in a vehicle rear part.

A floor harness composed of a left floor harness and a right floor harness arranged on respective sides in a vehicle width direction along a floor panel from a front part towards a rear part of a passenger compartment is provided. A rear end of the floor harness is in a vicinity of a panel that separates the passenger compartment and a rear luggage compartment. A rear harness is provided separately from the floor harness and is composed of a group of electric wires for connection to vehicle rear part-installed parts that include HEV parts including a battery that are installed in the vehicle rear part, a rear lamp, and a license-plate lamp.

One of the right and left floor harnesses and the rear harness are connector-connected when installed in the vehicle. The one floor harness for connection to the rear harness is configured as a common floor harness that is used commonly with other vehicle types produced on the same platform. All or some electric wires that are connected to optional electrical components are excluded from the common floor harness, and the electric wires that are excluded from the common floor harness and that are connected to the optional electrical components are included in the other floor harness.

The floor harness is connected to a junction box, a front end of which is installed in a passenger compartment front part, and is also connector-connected to an engine room harness and an instrument panel harness, and arranged towards the vehicle rear part. In addition, if the floor harness is divided and arranged on the right and left sides in the vehicle width direction as described above, the rear harness is connected to one of the floor harnesses as described above. It is preferable that said one floor harness connected to the rear harness is the left floor harness on the passenger side.

A reason why the place of division between the rear harness and one floor harness is in the vicinity of the panel that separates the backseat of the passenger compartment and the rear luggage compartment (trunk room) is that the HEV parts are installed in the rear luggage compartment and the HEV wire harness is added, and also that the places of installation of electrical components such as rear lamps are likely to be changed.

In the existing wire harness system, because the number of electric wires arranged in the vehicle rear part such as the rear luggage compartment is small, the rear harness is assembled integrally with the floor harness, but in the present invention, the HEV parts including the battery are installed in the vehicle rear part such as the trunk room, and thus the number of electric wires arranged in the vehicle rear part and the weight increase accordingly. Therefore, the rear harness is assembled separately from the floor harness, and the rear harness and the floor harness are connected to each other after being installed in a vehicle.

Accordingly, it is possible to prevent an increase of the floor harness size and to assemble the floor harness and the rear harness using wire harness assembly workbenches (drawing boards) with ordinary sizes. Also, an increase of the size is suppressed by dividing the wire harnesses, thus making it easy to both assemble the wire harnesses and arrange the wire harnesses in a vehicle.

As described above one floor harness is configured as a common floor harness that is used commonly with other vehicle types produced on the same platform, and the common floor harness is connector-connected.

At carmakers (vehicle assembly manufacturers), multiple vehicle types produced on the same platform include sedans, vans, wagons, box types, and the like with different vehicle rear designs, and the configuration of the rear luggage compartment and the places of installation of, for example, rear lamps and license-plate lamps are changed. In accordance with this change, it is necessary to change the wiring provided rearward of the backseat.

Therefore, the rear end of the floor harness that can be commonly used is disposed no farther than the passenger compartment rear end (backseat) position as described above, and the common floor harness and the rear harness are divided at the position of the partition panel that separates the passenger compartment and the rear luggage compartment.

All or some electric wires that are connected to optional electrical components are excluded from the common floor harness, and the electric wires that are excluded from the common floor harness and that are connected to the optional electrical components are included in the other floor harness.

That is, among the electric wires for connection to the optional electrical components, electric wires for connection to optional electrical components that are installed adjacent to the place where the common floor harness is arranged may be included in the common floor harness, but it is preferable that electrical wires including, for example, a group of long and heavy electric wires for connection to optional electrical components are not included in the common floor harness as much as possible to make the common floor harness light and small.

Regarding the wire harnesses arranged in a hybrid electric vehicle of the present invention, if a wire harness including 150 or more electrical wires is regarded as a large-size wire harness, there is a total of six such large-size wire harnesses, i.e., an instrument panel harness arranged in the instrument panel, an engine harness connected to the engine, an engine room harness arranged in the engine room, a right floor harness and a left floor harness that are arranged in the fore-aft direction along the right and left side edges of the floor, and a rear harness connected to any one of the right floor harness and the left floor harness and arranged in the vehicle rear part.

It should be understood that in the hybrid electric vehicle to which the present invention is directed, a door harness, a roof harness, and the like that have a smaller number of electric wires than the large-size wire harnesses are arranged.

In the present invention, the rear harness has a total weight of 2500 g to 3200 g, and the common floor harness connected to the rear harness has a total weight of 4500 g to 5200 g.

As described in the problems above, for a hybrid electric vehicle, if the HEV harness for arrangement in the trunk room is incorporated in the left floor harness, the weight of the left floor harness is about 9000 g, but if the left floor harness and the rear harness are divided as in the present invention, the specifically calculated weight of the left floor harness is about 5000 g and that of the rear harness is at 3000 g, thus totaling 8000 g, and a weight reduction of about 1000 g can be achieved.

The divided left floor harness and rear harness are connected to each other in the vicinity of the place where they are divided, and if the left floor harness and the rear harness are connected via multiple connectors, it is preferable that the multiple connectors connected to the end of said one wire harness are attached to a connector holder to create standby connectors, the connector holder is inserted into and fastened to a through-hole provided in the partition panel, and connectors connected to the end of the other wire harness are fit-connected to the connectors of said one wire harness.

If the left floor harness and the rear harness are connector-connected in one-to-one correspondence, it is preferable that a lock claw provided on the external surface of one connector is fastened to the periphery of the through hole provided in the partition panel, and the other connector is fit-connected to said one connector.

As described above, according to the present invention, in a hybrid electric vehicle in which an HEV system in which HEV parts such as a battery are installed in the vehicle rear part is disposed together with a conventional internal combustion engine drive system that uses gasoline, an HEV wire harness is not incorporated into a floor harness, a group of electric wires for, for example, rear lamp connection that would be arranged in the vehicle rear part using an existing floor harness and the HEV wire harness are combined into a rear harness, a floor harness is provided separately, and the separated rear harness and floor harness are connected after being arranged in the vehicle.

In this way, the floor harness and the rear harness are separated to prevent a size increase and weight increase of the floor harness, thus making it possible to improve the assembly workability and vehicle installation workability of the wire harness.

### BRIEF DESCRIPTION OF DRAWINGS

FIG. 1 is a schematic view of a hybrid electric vehicle of the first embodiment of the present invention.

FIG. 2 is a schematic plan view showing six large-size wire harnesses arranged in the hybrid electric vehicle.

FIG. 3(A) is a schematic view of a left floor harness that is used as a common floor harness, and FIG. 3(B) is a schematic view of a rear harness.

FIG. 4 is a schematic cross-sectional view showing a manner of connection between the left floor harness and the rear harness.

FIG. 5 shows the second embodiment, FIG. 5(A) is a schematic view of the end parts of the left floor harness and the rear harness that are connector-connected to each other, and FIG. 5(B) is a drawing showing a state in which connectors are held by a connector holder and connector-connected.

FIG. 6 shows the connector holder, FIG. 6(A) is a front view, FIG. 6(B) is a rear view, and FIG. 6(C) is a cross-sectional view.

FIG. 7 is a schematic view showing a conventional wire harness system.

FIG. 8(A) is a partial schematic plan view of a hybrid electric vehicle, and FIG. 8(B) is a drawing showing a left floor harness of a hybrid electric vehicle.

### DETAILED DESCRIPTION OF THE PREFERRED EMBODIMENTS

Embodiments of the present invention will now be described below with reference to the drawings.

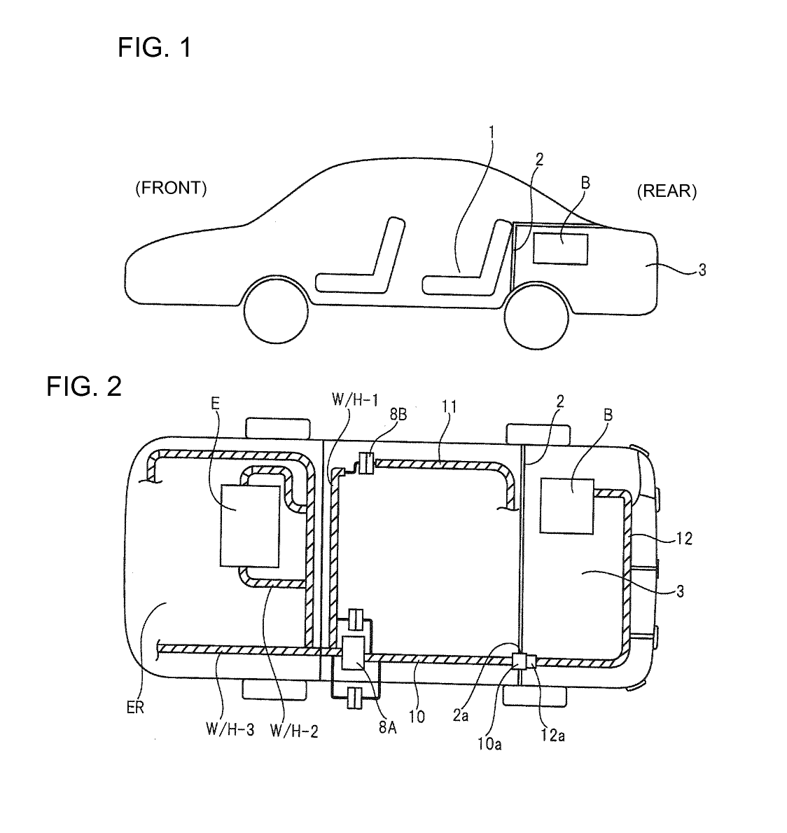

FIGS. 1 to 4 show the first embodiment of the present invention.

As shown in FIG. 1, the hybrid electric vehicle of the present invention is provided with HEV parts such as a high-energy drive battery B and a motor (not shown) connected to the battery B on a rear luggage compartment (trunk room) 3 side partitioned by a partition panel 2 at the back of a backseat 1.

The wire harnesses arranged in the hybrid electric vehicle are divided into six large-size wire harnesses and other small-size wire harnesses. The large-size wire harnesses each refer to a wire harness having 150 or more electric wires.

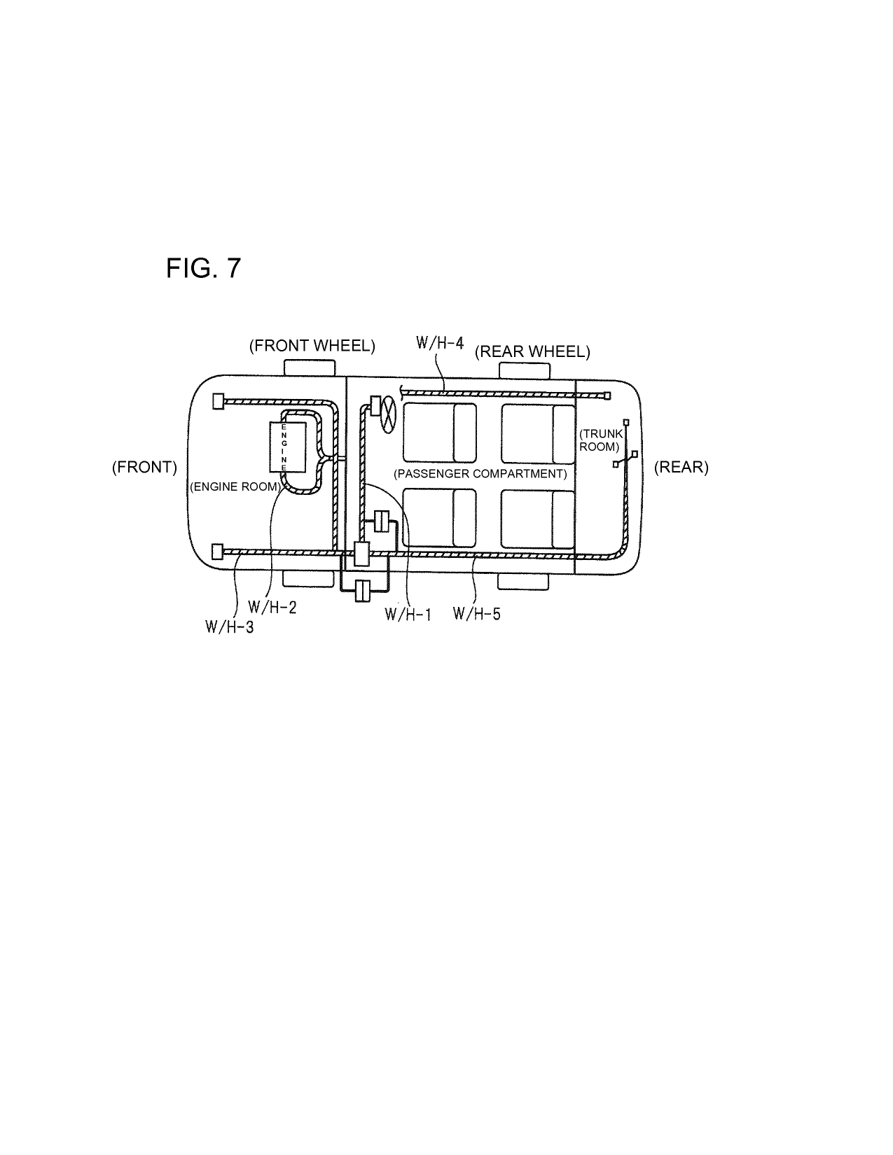

The six large-size wire harnesses include an instrument panel harness W/H-1, an engine harness W/H-2 connected to an engine E, an engine room harness W/H-3 arranged in an engine room ER, a left floor harness 10 and a right floor harness 11 that are arranged in the fore-aft direction along the right and left side edges of the floor, and a rear harness 12 arranged on the rear luggage compartment 3 side as arranged in FIG. 7. That is, as wire harnesses to be arranged in a hybrid electric vehicle, six large-size wire harnesses are provided.

In this way, the wire harness system in a hybrid electric vehicle is provided with the six large-size wire harnesses and wire harnesses other than the large-size wire harnesses including door harnesses each arranged for the right and left doors, a roof harness arranged for the roof, and the like, and the configurations of these wire harnesses are the same as those of conventional wire harnesses. That is, multiple groups of electric wires are bundled using an adhesive tape or a tie band, connectors are connected to the ends of these groups of electric wires, and a grounding terminal and a post-assembly terminal are connected to a necessary electric wire end, and the wire harnesses are externally furnished with a clip for fixation to the vehicle body or a protector or corrugate tube for, for example, protection or route-guiding.

The six large-size wire harnesses are each assembled on a different wire harness assembly workbench (drawing board). In this way, the wire harnesses that have been assembled on the respective drawing boards are separately arranged in a vehicle in the vehicle assembly line, and the wire harnesses are connector-connected to each other after being arranged. That is, the left floor harness 10, the right floor harness 11, and the rear harness 12 also are each assembled on a different drawing board.

The left floor harness 10 and the right floor harness 11 are respectively connector-connected to junction boxes 8A and 8B installed in the front part of the passenger compartment, and arranged toward the rear part of the vehicle.

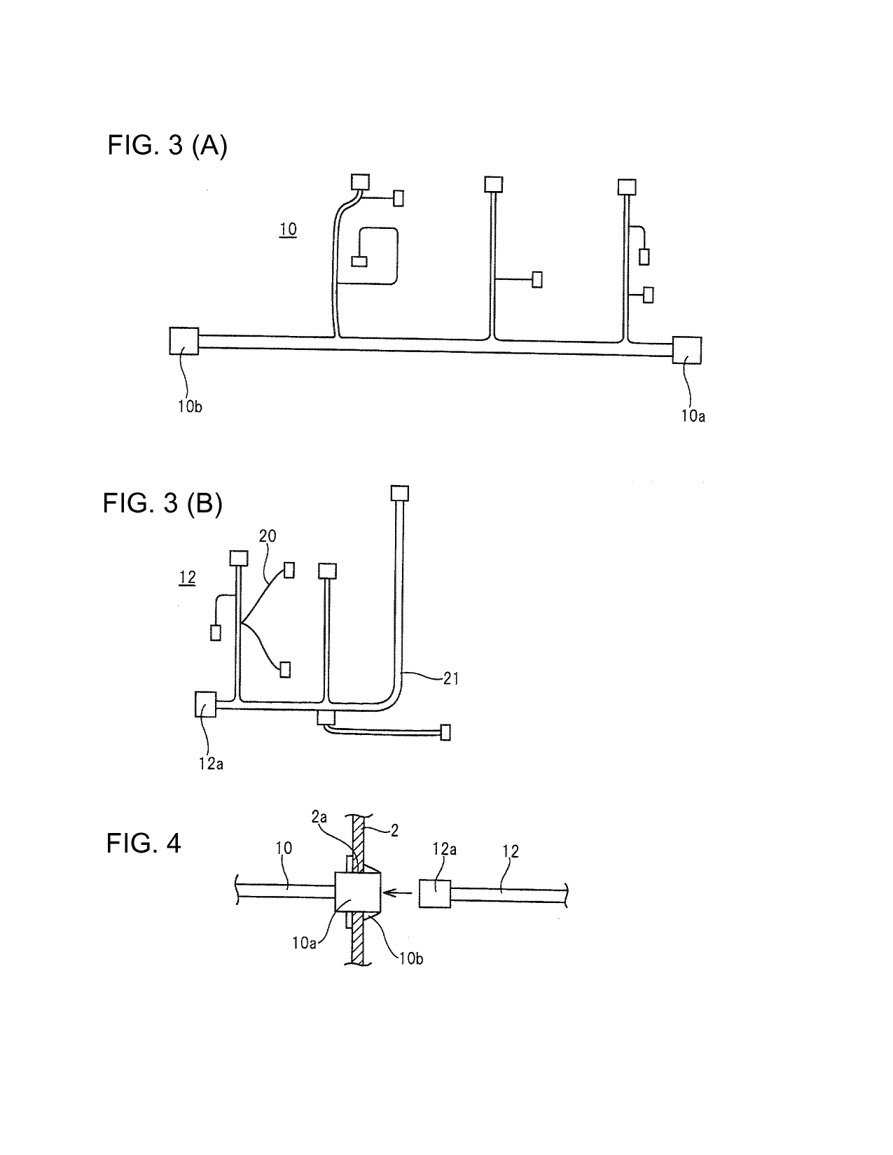

Among these floor harnesses, with regard to the left floor harness 10 that is connector-connected to the rear harness 12, a connector 10b that is connected to the front end is connected to the junction box 8A that is connected to the engine room harness W/H-3 as shown in FIG. 3(A). The connector 10a connected to the rear end of the left floor harness 10 is disposed where the partition panel 2 separates the backseat 1 and the rear luggage compartment 3.

The left floor harness 10 is configured as a wire harness that is commonly used in all vehicle types, e.g., sedans, vans, wagons and/or box-types assembled on platforms with the same configuration at a car maker.

Moreover, the left floor harness 10 used as a common floor harness does not include a group of electric wires for connection to optional electrical components that make the electric wires long and heavy, and thus has a light weight and a small size. Specifically, in this embodiment, a group of electric wires for connection to an audio system that is an optional electrical component are not included in the left floor harness 10 but are included in the right floor harness 11.

The rear harness 12 shown in FIG. 3(B) is composed of an HEV harness 20 connected to HEV parts such as the battery B, a motor, and the like installed in the rear luggage compartment 3 and a harness 21 connected to electrical parts such as rear lamps, license-plate lamps, and a defogger provided on the rear window. That is, the harness 21 that is a conventional harness provided in an internal combustion engine vehicle that uses gasoline fuel is combined with the HEV harness 20.

A connector 12a is attached to the front end of the rear harness 12 and fit-connected to the connector 10a at the rear end of the left floor harness 10 that serves as a common floor harness after being arranged in a vehicle.

As shown in FIG. 4, a through hole 2a is provided in the partition panel 2, the connector 10a is passed through the through hole 2a, a locking claw 10b provided so as to project on the external surface of the housing of the connector 10a is fastened and fixed to the peripheral edge of the through hole 2a, and thus the connector 10a serves as a standby connector. The connector 12a of the rear harness 12 is fitted to the connector 10a, and thus the left floor harness 10 and the rear harness 12 are connected.

Note that the connector 12a may be inserted into and fixed to the through hole 2a to allow it to serve as a standby connector.

The weight of the rear harness 12 is 2500 g to 3200 g (3066 g in this embodiment), the weight of the left floor harness 10 that serves as a common floor harness and that is connected to the rear harness 12 is 4500 g to 5200 g (5082 g in this embodiment), and the total weight is 8148 g in this embodiment.

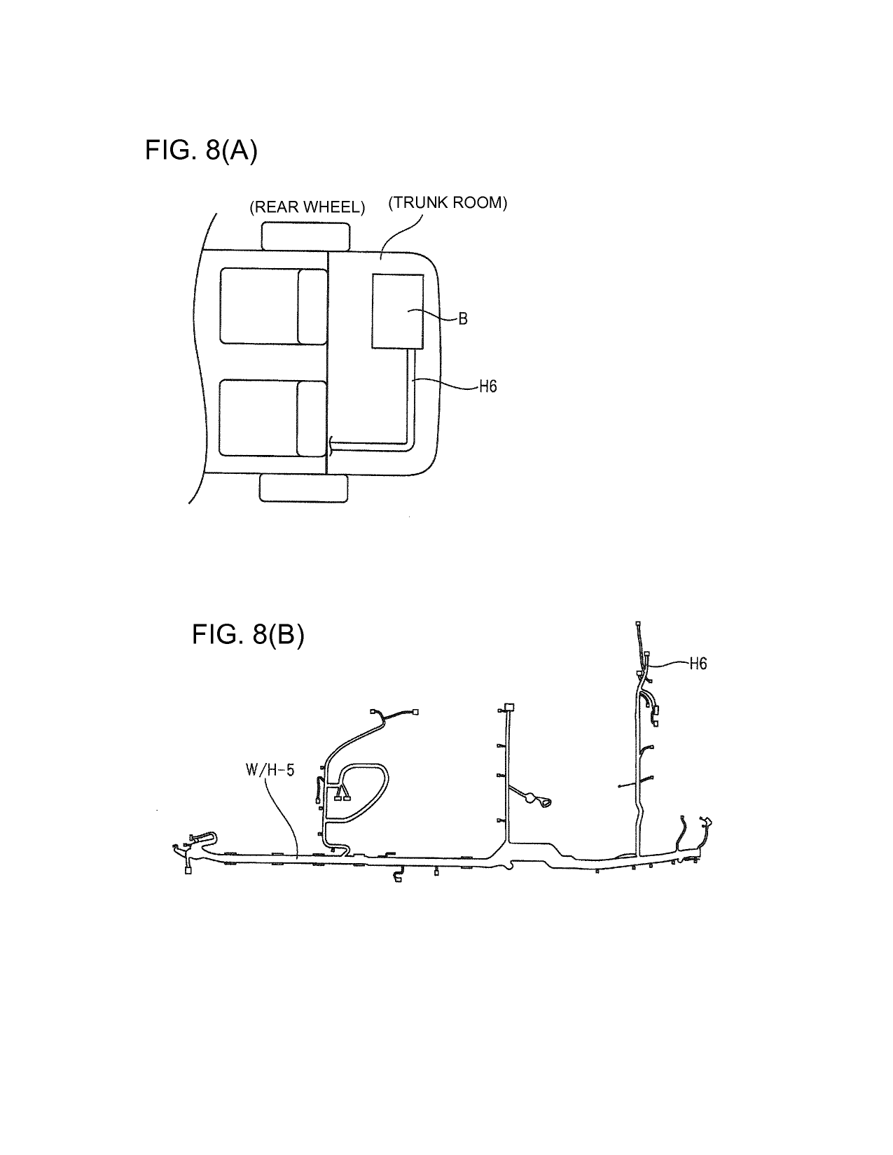

On the other hand, as shown in FIG. 8(B), if the rear harness and the left floor harness are not divided unlike in the present invention, and the HEV wire harness is incorporated into the conventional left floor harness so as to form a single wire harness, the total weight is 9286 g. Therefore, separating the rear harness can reduce about 1000 g of weight. In this way, the left floor harness has a reduced weight and a small size, and it is thus easy to handle the left floor harness.

As described above, although the wire harness becomes large and heavy and thus troublesome to handle if an HEV wire harness that is added to a hybrid electric vehicle is merely incorporated into the left floor harness of a conventional internal combustion engine vehicle, by separating the HEV wire harness from the left floor harness as a rear harness in which existing electric wires arranged in the vehicle rear part and added HEV electric wires are combined, a wire harness that is easy to handle in production and arrangement in a vehicle is achieved.

Specifically, widely used drawing boards that are conventionally used as drawing boards for wire harness assembly work can be used. Also, it is possible to reduce the workload in the respective steps of wire harness assembly work. Moreover, because the wire harness has a small size and a light weight, the workload of arranging the wire harness in a vehicle can be reduced.

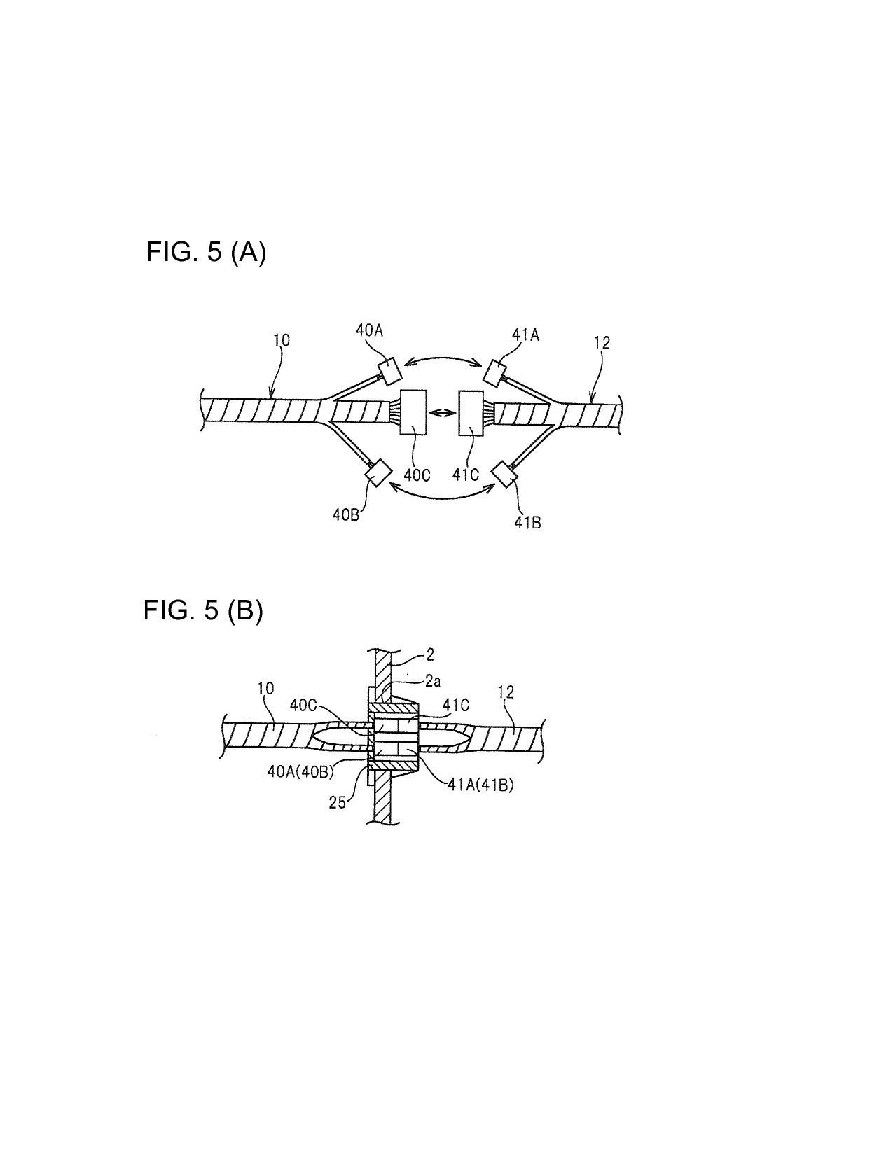

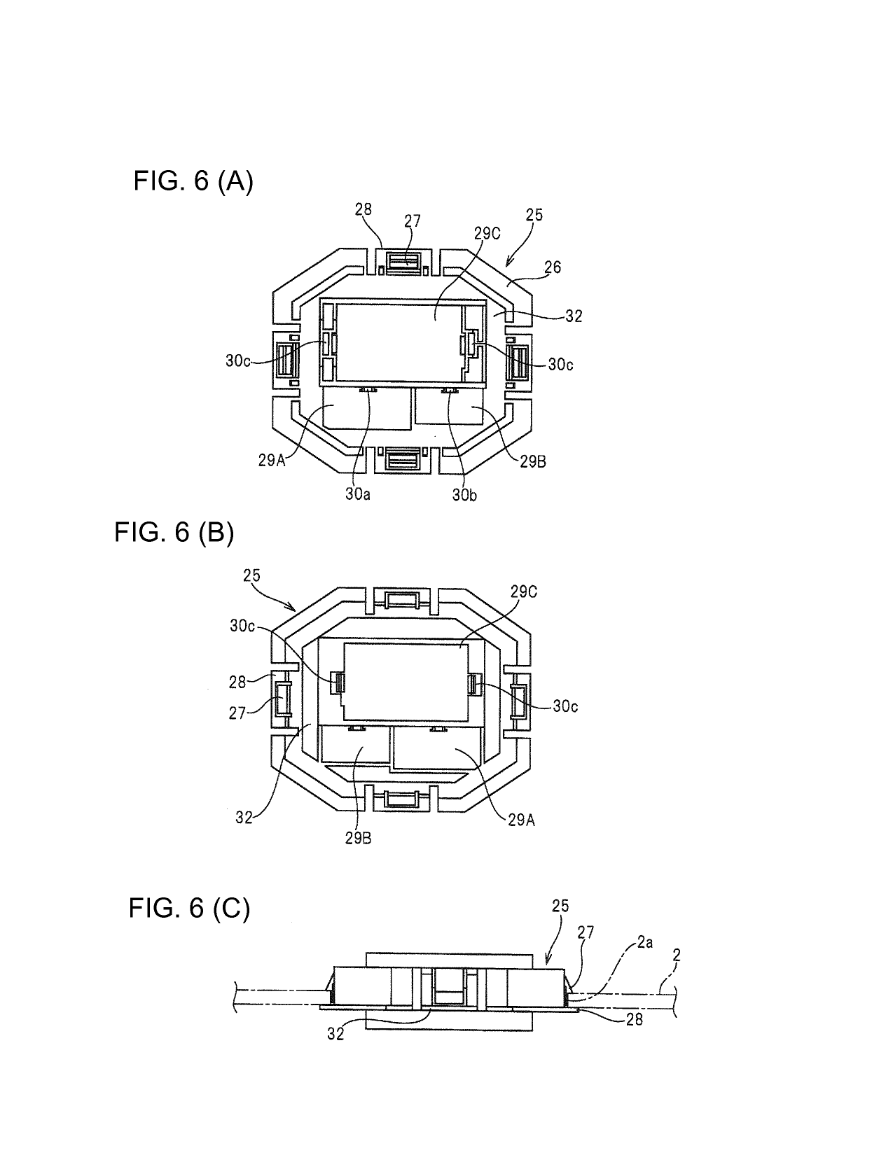

FIGS. 5 and 6 show the second embodiment.

In the second embodiment, as shown in FIG. 5(A), the rear end of the left floor harness 10 is branched into three branch lines and, connectors 40A, 40B, and 40C are respectively connected to the branch lines. The front end of the rear harness 12 that is connector-connected to the left floor harness 10 is also divided into three branch lines in the same manner, and connectors 41A, 41B, and 41C are respectively connected to the branch lines.

Accordingly, connection of the left floor harness 10 and the rear harness 12 requires the three connectors of the respective harnesses to be fit into each other. Therefore, as shown in FIG. 5(B), the connectors are attached to the through hole 2a of the partition panel 2 via a connector holder 25.

The through hole 2a is an octagonal hole, and as shown in FIG. 6 the connector holder 25 is a resin-molded article with an octagonal external shape so as to internally fit into the through hole 2a.

In the central parts of the upper, lower, right, and left four sides of the sides of a peripheral frame 26 of the octagon of the connector holder 25, lock claws 27 that fasten to one surface of the partition panel 2 around the through hole 2a project from the insertion end side, and panel receiving pieces 28 are provided so as to project from the opposite end and brought into contact with the other surface of the partition panel 2.

Also, three through holes 29A to 29C are provided in a central part 32 enclosed by the peripheral frame 26, lock parts 30a to 30c are respectively provided on the inner peripheral surfaces of the through holes 29A to 29C and lock-coupled with lock-receiving parts (now shown) provided on the external surfaces of the housings of the connectors 40A, 40B, and 40C.

Regarding the connector holder 25, the connectors 40A to 40C of the left floor harness 10 are inserted into the through holes 29A to 29C and lock-fixed by the lock parts 30a to 30c, and thus the connectors 40A to 40C are attached to the connector holder 25 in advance as standby connectors.

When arranging the left floor harness 10 in a vehicle, the connector holder 25 is inserted into the through hole 2a of the partition panel 2, the lock claws 27 are fastened to one surface side around the through hole 2a, and the panel receiving pieces 28 are brought into contact with the other surface.

The rear harness 12 is arranged in the vehicle, and the connectors 41A to 41C connected to the front end of the rear harness 12 are respectively fitted to the standby connectors 40A to 40C that have been fixed to the connector holder 25 in advance.

As described above, the connector holder 25 is used, and the connector holder 25 is internally fitted and fixed to the through hole 2a, thus making it possible to mutually connect multiple connectors at the ends of wire harnesses through one through hole 2a.

1. A wire harness system in a hybrid electric vehicle in which HEV parts including a battery are installed in a vehicle rear part, wherein
a floor harness that is arranged along a floor panel from a front part towards a rear part of a passenger compartment is provided, and a rear end of the floor harness is in a vicinity of a panel that separates the passenger compartment and a rear luggage compartment,
a rear harness composed of a group of electric wires for connection to vehicle rear part-installed parts that include HEV parts including a battery that are installed in the vehicle rear part, a rear lamp, and a license-plate lamp is provided separately from the floor harness, and
the floor harness and the rear harness are connected to each other when installed in the vehicle.

2-4. (canceled)

5. The wire harness system in a hybrid electric vehicle according to claim 1, comprising a total of six large-size wire harnesses, i.e., an instrument panel harness arranged in an instrument panel, an engine harness connected to an engine, an engine room harness arranged in an engine room, a right floor harness and a left floor harness that are arranged in a fore-aft direction along right and left side edges of a floor, and a rear harness arranged in the vehicle rear part and connected to any one of the right floor harness and the left floor harness, with a wire harness including 150 or more electrical wires being regarded as the large-size wire harness.

6. The wire harness system in a hybrid electric vehicle according to claim 5, wherein the rear harness has a total weight of 2500 g to 3200 g, and said one floor harness connected to the rear harness has a total weight of 4500 g to 5200 g.

7. The wire harness system in a hybrid electric vehicle according to claim 1, wherein the rear harness has a total weight of 2500 g to 3200 g, and said one floor harness connected to the rear harness has a total weight of 4500 g to 5200 g.
